(19) United States
(12) Patent Application Publication
(10) Pub. No.: US 2019/0086840 A1
(43) Pub. Date: Mar. 21, 2019

(54) INTERMEDIATE TRANSFER BODY, METHOD FOR MANUFACTURING INTERMEDIATE TRANSFER BODY, AND IMAGE FORMING DEVICE

(71) Applicant: Konica Minolta, Inc., Tokyo (JP)

(72) Inventors: Kazunori KURIMOTO, Tokyo (JP); Akihiro HONYA, Tokyo (JP); Teruo SASAKI, Tokyo (JP)

(21) Appl. No.: 16/115,106

(22) Filed: Aug. 28, 2018

(30) Foreign Application Priority Data
Sep. 21, 2017 (JP) 2017-180793

(51) Int. Cl. G03G 15/16; G03G 15/01; C08L 71/02; C08L 57/10

(52) U.S. Cl. CPC G03G 15/162; C08L 57/10; C08L 71/02; G03G 15/0157

(57) ABSTRACT

There is provided an intermediate transfer body used for an electrophotographic image forming device, the intermediate transfer body including: at least a base layer, and a surface layer, wherein the surface layer includes a polymer obtained by polymerizing a polyfunctional monomer and a monofunctional monomer having a long-chain alkyl group, and a solubility parameter (SP (M1)) of the polyfunctional monomer (M1) and a solubility parameter (SP (M2)) of the long-chain alkyl monofunctional monomer (M2) satisfy the following formulas (A) and (B):

SP(M1)−SP(M2)<2.0(cal/cm³)^{1/2} Formula (A);

and

8.0≤SP(M2)≤9.0(cal/cm³)^{1/2} Formula (B).

The entire disclosure of Japanese patent Application No. 2017-180793, filed on Sep. 21, 2017, is incorporated herein by reference in its entirety.

### BACKGROUND

### Technological Field

The present invention relates to an intermediate transfer body, a method for manufacturing the intermediate transfer body, and an image forming device, and in particular to an intermediate transfer body and the like capable of improving cleaning performance of toner and maintaining the cleaning performance over a long term.

### Description of the Related Art

In an electrophotographic image forming device, for example, a latent image formed on a photoreceptor is developed with toner, the obtained toner image is temporarily held on an endless belt-shaped intermediate transfer body, and the toner image on the intermediate transfer body is transferred onto a recording medium such as paper. As the shape of such an intermediate transfer body, an endless belt (intermediate transfer belt) is known.

The intermediate transfer belt includes a base layer made of resin and a surface layer made of a curable resin disposed on the base layer. In an intermediate transfer belt described in JP 2013-024898 A, when a cleaning member (cleaning blade) constituted by an elastic body for cleaning the intermediate transfer belt is disposed, a dynamic frictional force (dynamic torque) of the intermediate transfer belt may increase. In particular, the dynamic frictional force of the intermediate transfer belt tends to remarkably increase between a general environment (20° C., 50% RH; “NN environment”) and a high temperature and high humidity environment (30° C., 80% RH; HH environment). In a case of using the intermediate transfer belt described in JP 2013-024898 A, the intermediate transfer belt has excellent durability. Therefore, the intermediate transfer belt is not abraded, but the cleaning member may be abraded.

In addition, in order to secure cleaning performance of toner, inventions using a fluorine material or a silicone material are known (for example, see JP 2013-231964 A and JP 2016-206643 A). However, a fluorine material and a silicone material tend to be segregated on a surface of an intermediate transfer belt, and can be used in an initial stage, but hardly maintain cleaning performance of toner over a long term.

In addition, an intermediate transfer belt using a long-chain alkyl monofunctional monomer having a higher affinity with a monomer than the above fluorine material and silicone material is known (for example, see JP 2007-316622 A).

However, in the intermediate transfer belt described in JP 2007-316622 A, compatibility between a monomer serving as a mother skeleton and the long-chain alkyl monofunctional monomer is poor, and the long-chain alkyl monofunctional monomer is segregated on a surface. Therefore, a cleaning function can be accomplished only in an initial stage, and sufficient performance cannot be satisfied against high durability in recent years.

### SUMMARY

The present invention has been achieved in view of the above problems and circumstances, and an object of the present invention is to provide an intermediate transfer body capable of improving cleaning performance of toner and maintaining the cleaning performance over a long term, a method for manufacturing the intermediate transfer body, and an image forming device.

To achieve the abovementioned object, according to an aspect of the present invention, an intermediate transfer body used for an electrophotographic image forming device, reflecting one aspect of the present invention comprises: at least a base layer, and a surface layer, wherein the surface layer includes a polymer obtained by polymerizing a polyfunctional monomer and a monofunctional monomer having a long-chain alkyl group, and a solubility parameter (SP (M1)) of the polyfunctional monomer (M1) and a solubility parameter (SP (M2)) of the long-chain alkyl monofunctional monomer (M2) satisfy the following formulas (A) and (B):

SP(M1)−SP(M2)<2.0(cal/cm³)^{1/2} Formula (A);

and

8.0≤SP(M2)≤9.0(cal/cm³)^{1/2} Formula (B).

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating an example of an image forming device according to the present embodiment; and

FIG. 2 is a diagram for explaining a maximum abrasion width of a cleaning blade in a friction test.

### DETAILED DESCRIPTION OF EMBODIMENTS

Hereinafter, one or more embodiments of the present invention will be described with reference to the drawings. However, the scope of the invention is not limited to the disclosed embodiments.

An intermediate transfer body according to an embodiment of the present invention is an intermediate transfer body used for an electrophotographic image forming device, and includes at least a base layer and a surface layer, characterized in that the surface layer includes a polymer obtained by polymerizing a polyfunctional monomer and a monofunctional monomer having a long-chain alkyl, and a solubility parameter (SP (M1)) of the polyfunctional monomer (M1) and a solubility parameter (SP (M2)) of the long-chain alkyl monofunctional monomer (M2) satisfy the following formulas (A) and (B).

SP(M1)−SP(M2)<2.0(cal/cm³)^{1/2} Formula (A)

8.0≤SP(M2)≤9.0(cal/cm³)^{1/2} Formula (B)

In an embodiment of the present invention, the long-chain alkyl monofunctional monomer is preferably a long-chain alkyl monofunctional monomer in which 6 or more carbon atoms are connected from a viewpoint of favorable water repellency, and the long-chain alkyl monofunctional monomer is more preferably a long-chain alkyl monofunctional monomer in which 12 or more carbon atoms are connected.

The polyfunctional monomer preferably has a structure represented by the following general formula (1) from a viewpoint of being able to obtain a high releasing effect because a long-chain alkyl group tends to be oriented to the outside of a polymer skeleton after polymerization.

The X preferably has a skeleton of either an oxypropylene chain or an alkylene oxide chain from a viewpoint of being able to prevent turnover of a cleaning blade in the HH environment.

The polyfunctional monomer preferably has five or more functional groups from a viewpoint of scratch resistance because of favorable abrasion resistance.

The surface layer preferably includes a polymer obtained by polymerizing a monomer having an acryloyl group or a methacryloyl group from a viewpoint of a high polymerization reaction rate and favorable productivity.

The content of a constituent derived from the long-chain alkyl monofunctional monomer is preferably within a range of 5 to 20 parts by volume with respect to the total volume (100 parts by volume) of the surface layer from a viewpoint of obtaining an excellent releasing effect and favorable cleaning performance.

A method for manufacturing an intermediate transfer body according to an embodiment of the present invention preferably uses a surface layer forming coating solution containing a long-chain alkyl monofunctional monomer within a range of 5 to 20 parts by volume with respect to the total volume (100 parts by volume) of solid components constituting the surface layer from a viewpoint of obtaining an excellent releasing effect and favorable cleaning performance.

The intermediate transfer body according to an embodiment of the present invention is preferably used for an image forming device.

Hereinafter, the present invention, constituent elements thereof, and embodiments and modes for performing the present invention will be described in detail. Incidentally, in the present application, “to” means inclusion of numerical values described before and after “to” as a lower limit value and an upper limit value.

[Intermediate Transfer Body]

The intermediate transfer body primarily transfers a toner image carried on an electrostatic latent image carrier (photoreceptor), and then secondarily transfers the primarily transferred toner image onto a recording medium, and is incorporated in the image forming device.

The intermediate transfer body includes a base layer and a surface layer. In addition, in the intermediate transfer body, the base layer is located inside, and the surface layer is located outside.

Note that an elastic layer constituted by an elastic material may be disposed between the base layer and the surface layer. An elastic layer having a known structure can be used.

The intermediate transfer body has an endless belt shape. Here, the “endless belt shape” conceptually (geometrically) means, for example, a loop-like shape formed by joining both end portions of one elongated sheet-shaped material. The actual shape of the intermediate transfer body is preferably a seamless belt shape or a cylindrical shape.

<Base Layer>

The base layer is made of a resin and can be appropriately selected from resins not modified or deformed within a range of use temperature of the intermediate transfer body. Examples of resins used include polycarbonate, polyphenylene sulfide, polyvinylidene fluoride, polyimide, polyamide imide, polyalkylene terephthalate (polyethylene terephthalate, polybutylene terephthalate, or the like), polyether, polyether ketone, polyether ether ketone, an ethylene tetrafluoroethylene copolymer, and polyamide.

As the resin, it is preferable to contain polyimide, polycarbonate, polyphenylene sulfide, and polyalkylene terephthalate, and more preferable to contain polyphenylene sulfide or polyimide from a viewpoint of heat resistance and strength.

Polyimide can be obtained by heating polyamic acid which is a precursor of polyimide. In addition, polyamic acid can be obtained by dissolving a tetracarboxylic acid dianhydride or a substantially equimolar mixture of a derivative of a tetracarboxylic acid dianhydride and a diamine in an organic polar solvent, and allowing these compounds to react in a solution state. Incidentally, in a case where a polyimide-based resin is used as the base layer, the content of the polyimide-based resin in the base layer is preferably 51% by mass or more.

In addition, the base layer preferably has an electric resistance value (volume resistivity) in a range of 10⁵ to 10¹¹ Ω·cm. In order to make the electric resistance value of the base layer within a predetermined range, the base layer only needs to contain, for example, a conductive material. Examples of the conductive material include carbon black. As the carbon black, neutral or acidic carbon black can be used. Although varying depending on the type of conductive material, it is only required to add a conductive material such that the intermediate transfer body has a volume resistance value and a surface resistance value within a predetermined range. It is only required to add a conductive material usually within a range of 10 to 20 parts by mass, preferably within a range of 10 to 16 parts by mass with respect to 100 parts by mass of a resin.

In addition, the base layer preferably has a thickness within a range of 50 to 200 μm. Various known additives may be further added to the base layer. Examples of the additive include a dispersant such as a nylon compound.

The base layer can be manufactured by a conventionally known general method. For example, the base layer can be manufactured into an annular shape (endless belt shape) by melting a heat resistant resin as a material by an extruder, shaping the melted product into a tubular shape by an inflation method using an annular die, and then cutting the shaped product into round slices.

<Surface Layer>

The surface layer includes a polymer obtained by polymerizing a polyfunctional monomer and a monofunctional monomer having a long-chain alkyl, and is characterized in that a solubility parameter (SP (M1)) of the polyfunctional monomer (M1) and a solubility parameter (SP (M2)) of the long-chain alkyl monofunctional monomer (M2) satisfy the following formulas (A) and (B).

SP(M1)−SP(M2)<2.0(cal/cm³)^{1/2} Formula (A)

8.0≤SP(M2)≤9.0(cal/cm³)^{1/2} Formula (B)

Preferably, the following formulas (C) and (D) are satisfied.

1.0<SP(M1)−SP(M2)<1.9(cal/cm³)^{1/2} Formula (C)

8.5≤SP(M2)≤8.9(cal/cm³)^{1/2} Formula (D)

In the present invention, a solubility parameter (SP value) is calculated by Fedors. Documents referred to are the following. Reference Document: “Basic Science of Coating” by Yuji Harasaki, published by Maki Shoten, p 54-p 57

$$δ = {( \frac{Δ E}{V} )}^{1 \text{/} 2} = {( \frac{{\sum }_{i} Δ {e}_{i}}{{\sum }_{i} Δ {v}_{i}} )}^{1 \text{/} 2} \qquad [ Numerical formula 1 ]$$

In the above formula, ΔE and V are symbols representing grazing energy density and molar volume, respectively, and Δeᵢ and Δvᵢ are symbols representing evaporation energy and molar volume of an atom or an atomic group, respectively.

The SP value is a value (δ) calculated from values of Δeᵢ and Δvᵢ in the book. Note that the unit of the SP value calculated from the above formula is (cal/cm³)^{1/2}.

(Long-Chain Alkyl Monofunctional Monomer)

The long-chain alkyl monofunctional monomer has a hydrophobic long-chain alkyl group and a functional group (reactive group). The long-chain alkyl monofunctional monomer is preferably an alkyl monofunctional monomer in which 6 or more carbon atoms are continuously connected from a viewpoint of favorable water repellency, and is more preferably an alkyl monofunctional monomer in which 12 or more carbon atoms are continuously connected. An upper limit value of the number of carbon atoms is preferably 25 or less from viewpoints of easy availability and excellent solubility.

The long-chain alkyl monofunctional monomer may have a branched structure, but the number of connected carbon atoms is calculated as the number of continuously connected carbon atoms in a carbon chain having the largest length in a molecule. For example, in a case where a long-chain alkyl moiety is ethylhexyl, the carbon number of the long-chain alkyl moiety is eight, but the number of continuous carbon atoms is calculated as an alkyl monofunctional monomer in which six carbon atoms are connected continuously.

Note that “connected continuously” means a series of bonds between carbon atoms, and no other element is allowed to be interposed therebetween.

The addition amount of a constituent (component) derived from the long-chain alkyl monofunctional monomer is preferably within a range of 1 to 30 parts by volume, particularly preferably within a range of 5 to 20 parts by volume with respect to the total volume (100 parts by volume) of the surface layer. Within a range of 1 to 30 parts by volume, an excellent releasing effect and favorable cleaning performance are obtained.

In the present invention, as a method for analyzing components constituting the surface layer, a generally used method can be used. As a method for analyzing a composition ratio of a monomer, it is possible to use solid NMR or a method for identifying a structure after hydrolyzing a shaped product using NMR, GC-MS, LC-MS, or the like to determine a molar fraction.

In addition, as a method for calculating a volume ratio of each component, the volume ratio can be calculated by multiplying the molar fraction determined as described above by a specific gravity. As the specific value, a general value such as a maker value may be used. In a case where metal oxide fine particles described below are added to the surface layer, the structure can be estimated by elemental analysis.

In the present invention, calculation can be performed by assuming that the specific gravities of components constituting the surface layer are 0.9 for a long-chain alkyl monofunctional monomer, 1.1 for a polyfunctional monomer, 3.7 for titania as the metal oxide fine particles, and 2.2 for silica.

Examples of the long-chain alkyl group include n-butyl, n-pentyl, n-hexyl, n-octyl, n-nonyl, n-decanyl, lauryl, myristyl, palmityl, cetyl, stearyl, behenyl, 2-ethylhexyl, isooctyl, isononyl, isodecanyl, isolauryl, isomyristyl, isopalmityl, isocetyl, isostearyl, and 2-decyltetradecanyl.

(Polyfunctional Monomer)

The polyfunctional monomer is a monomer having a bifunctional or higher functional group.

The polyfunctional monomer needs to be a main component of monomers. The main component is present in an amount of 50% or more by volume of monomers.

The polyfunctional monomers may be mixed to be used. In this case, an SP value of the polyfunctional monomers is calculated as a value averaged based on volume ratios.

The polyfunctional monomer is characterized by having a structure represented by the following general formula (1).

A-[(X)-M]ₘ(M)ₙ General formula (1)

[In the formula, A represents a bifunctional or higher functional monomer. X represents a connecting group having a chain skeleton in which three or more atoms on an average are connected, and at least one of the atoms is a carbon, nitrogen or oxygen atom. M represents a photopolymerizable functional group. Each of m and n represents the number of functional groups and is an integer of 1 or more, and m+n is an integer of 2 to 6.]

In the above general formula (1), A represents a bifunctional or higher functional monomer.

The structure of A is not particularly limited, and examples of A include bisphenol A, cyclodecane, neopentyl, trimethylolpropane, glycerin, isocyanurate, pentaerythritol, ditrimethylolpropane, and dipentaerythritol.

Examples of A further include the following structures A1 to A9.

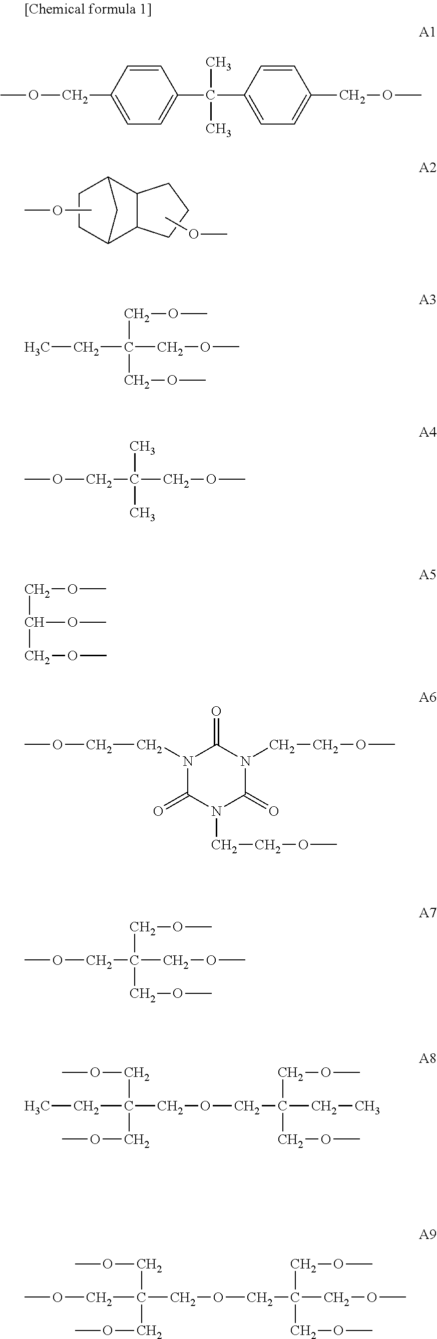

X is generally a moiety modified from a main skeleton by EO modification or the like and represents a connecting group having a chain skeleton in which three or more atoms on an average are connected, and at least one of the atoms is a carbon, nitrogen, or oxygen atom.

Here, “three or more atoms on an average” means that the number of connected atoms constituted by carbon, nitrogen, or oxygen atoms is three or more. In a case where X has a branched structure, “three or more atoms on an average” means that the number of atoms in a main chain is three or more. For example, oxypropylene has four atoms, but in the case of the present invention, the number of atoms is calculated as three.

In a case where a plurality of Xs coexists in a polyfunctional monomer, the number of connected atoms is calculated as an average number per functional group.

X is preferably an oxypropylene chain, an alkylene oxide chain, or an oxyethylene chain, and particularly preferably an oxypropylene chain or an alkylene oxide chain from a viewpoint of preventing turnover of a cleaning blade in an HH environment.

The specific structure of X is illustrated below.

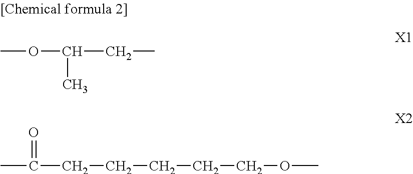

M is not particularly limited as long as being a photopolymerizable functional group.

Examples of the photopolymerizable functional group include a vinyl group, a (meth)acryloyl group, an allyl group, an epoxy group, and a vinyl ether group. The (meth)acryloyl group is particularly preferable from a viewpoint of a curing reaction rate.

Here, the “(meth)acryloyl group” means an acryloyl group or a methacryloyl group.

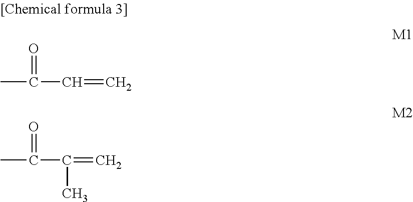

Each of m and n represents the number of functional groups and is an integer of 1 or more.

m+n is an integer of 2 to 6, and preferably an integer of 5 or 6.

The polyfunctional monomer according to an embodiment of the present invention preferably has five or more functional groups from viewpoints of favorable abrasion resistance and scratch resistance.

The surface layer according to an embodiment of the present invention preferably includes a polymer obtained by polymerizing a monomer having an acryloyl group or a methacryloyl group from viewpoints of a high polymerization reaction rate and favorable productivity. That is, at least one of the long-chain alkyl monofunctional monomer and the polyfunctional monomer preferably has an acryloyl group or a methacryloyl group.

(Metal Oxide Fine Particles)

The surface layer according to an embodiment of the present invention preferably includes metal oxide fine particles obtained by surface-modifying metal oxide fine particles that have not been treated (hereinafter also referred to as “untreated metal oxide fine particles”) with a specific surface modifier.

The untreated metal oxide fine particles only need to be formed of an oxide of a metal including a transition metal, and examples thereof include silica (silicon oxide), magnesium oxide, zinc oxide, lead oxide, aluminum oxide (alumina), tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, and vanadium oxide.

The untreated metal oxide fine particles are preferably formed of titanium oxide, aluminum oxide (alumina), zinc oxide, or tin oxide, and more preferably formed of aluminum oxide (alumina) or tin oxide from a viewpoint of imparting toughness and durability.

As the untreated metal oxide fine particles, those manufactured by a general manufacturing method such as a vapor phase method, a chlorine method, a sulfuric acid method, a plasma method, or an electrolysis method can be used.

The untreated metal oxide fine particles have a number average primary particle diameter preferably within a range of 1 to 300 nm, more preferably within a range of 3 to 100 nm. In a case where the number average primary particle diameter is 1 nm or more, abrasion resistance is sufficient. In a case where the number average primary particle diameter is 300 nm or less, dispersibility is favorable, and the particles are hardly precipitated in a coating solution. In addition, the particles do not inhibit photocuring of the surface layer, and favorable abrasion resistance is obtained.

The number average primary particle diameter of the untreated metal oxide fine particles is determined by photographing an enlarged photograph at a magnification of 10000 times with a scanning electron microscope (manufactured by JEOL Ltd.), capturing randomly selected 300 particles by a scanner to obtain a photographic image (except for aggregated particles), and calculating a number average primary particle diameter of the particles using an automatic image processing analyzer “(trade name: LUZEX AP” manufactured by Nireco Corporation) Software Version Ver. 1.32.

A surface modifier for manufacturing the surface-modified metal oxide fine particles according to an embodiment of the present invention is not particularly limited, and preferably contains Si. The amount of surface modification is determined by thermally treating surface-modified metal oxide fine particles at 550° C. for three hours, quantitatively analyzing the strong heat residue with fluorescent X-rays, and converting the Si amount into a molecular weight.

For the surface modification, a wet media dispersion type device can be used. The wet media dispersion type device can execute a step of pulverizing and dispersing aggregated particles of the metal oxide fine particles by filling beads as media in a container and rotating a stirring disk attached perpendicularly to a rotating shaft at a high speed. As a configuration of the device, it is possible to adopt a device capable of dispersing the untreated metal oxide fine particles sufficiently when the untreated metal oxide fine particles are surface-modified and performing surface modification without any particular problem. For example, various types such as a vertical type, a horizontal type, a continuous type, and a batch type can be adopted. Specific examples thereof include a sand mill, an ultra visco mill, a pearl mill, a glen mill, a dyno mill, an agitator mill, and a dynamic mill. These dispersion type devices perform fine pulverization and dispersion by impact crushing, friction, shearing, shear stress, and the like using a pulverizing medium such as balls or beads. As the beads used in the dispersion type device, balls made of glass, alumina, zircon, zirconia, steel, flintstone, or the like can be used, and beads made of zirconia or zircon are particularly preferable. In addition, as the sizes of the beads, beads each having a diameter of about 1 to 2 mm are usually used. However, in the present embodiment, beads each having a diameter of about 0.3 to 1.0 mm are preferably used.

Various materials such as stainless steel, nylon, and ceramic can be used for a disk and an inner wall of a container used for the wet media dispersion type device. However, in the present embodiment, a ceramic material such as zirconia or silicon carbide is particularly preferably adopted.

By the wet treatment as described above, the surface-modified metal oxide fine particles can be obtained.

The surface-modified metal oxide fine particles as described above are included preferably in an amount of 5 to 40 parts by volume, more preferably in an amount of 10 to 30 parts by volume with respect to 100 parts by volume of a polymer obtained by polymerizing a long-chain alkyl monofunctional monomer and a polyfunctional monomer. If the content of the metal oxide fine particles is within a range of 5 to 40 parts by volume, the hardness of the intermediate transfer body is lowered, and there is no possibility that transferability and durability are lowered. In addition, there is no possibility that a surface layer is brittle and easily broken or coating unevenness occurs during manufacturing.

The surface layer according to an embodiment of the present invention may further contain another additive. The additive is appropriately added to the surface layer, for example, by adding the additive to a curable composition. The other additive may be added to the curable composition in order to impart appropriate physical properties for manufacturing the surface layer.

Examples of the other additive include a polymerization initiator, an organic solvent, a light stabilizer, an ultraviolet absorber, a catalyst, a colorant, an antistatic agent, a lubricant, a leveling agent, a defoaming agent, a polymerization accelerator, an antioxidant, a flame retardant, an infrared absorber, a surfactant, and a surface modifier.

The intermediate transfer body according to an embodiment of the present invention can be manufactured by, for example, applying a surface layer forming coating solution containing the above-described polymer obtained by polymerizing a long-chain alkyl monofunctional monomer and a polyfunctional monomer, and, as necessary, the metal oxide fine particles and the above additive onto the base layer and irradiating the coating solution with active energy rays so as to obtain a predetermined light amount.

The surface layer forming coating solution preferably contains a long-chain alkyl monofunctional monomer within a range of 5 to 20 parts by volume with respect to the total volume (100 parts by volume) of solid components constituting the surface layer.

[Image Forming Device]

As long as including the above-described intermediate transfer body according to an embodiment of the present invention, the image forming device according to an embodiment of the present invention can adopt a known configuration as a configuration other than the intermediate transfer body without any particular limitation.

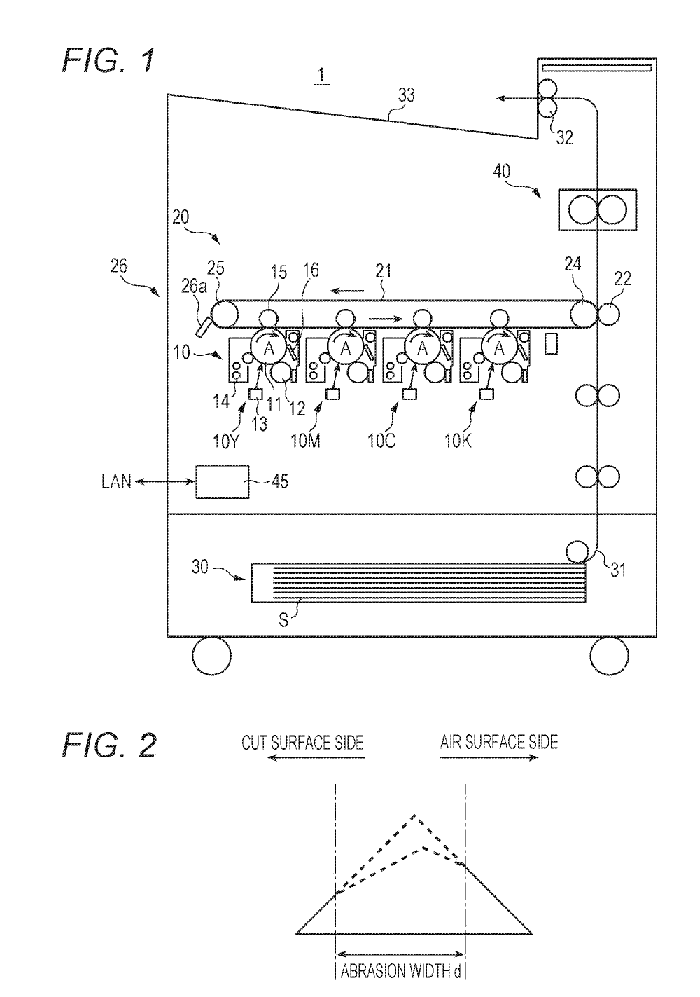

FIG. 1 is a schematic diagram illustrating an example of the image forming device according to an embodiment of the present invention.

As illustrated in FIG. 1, an image forming device 1 forms an image on a recording medium by a known electrophotographic method, includes an image forming section 10, an intermediate transfer unit 20, a sheet conveyer 30, a fixer 40, and a controller 45, and selectively executes color and monochrome printing based on a print job accepted from an external terminal device (not illustrated) via a network (for example, LAN).

The image forming section 10 includes image forming units 10Y to 10K corresponding to developing colors of yellow (Y), magenta (M), cyan (C), and black (K), respectively. The image forming unit 10Y includes a photosensitive drum 11 as an electrostatic latent image carrier, a charging device 12 disposed around the photosensitive drum 11, an exposing device 13, a developing device 14, a primary transfer roller 15, a photosensitive cleaning device 16, a belt cleaning device 26, and a secondary transfer roller 22.

The photosensitive drum 11 is, for example, a negatively charged organic photoreceptor and rotates in a direction indicated by the arrow A. The charging device 12 charges a peripheral surface of the photosensitive drum 11. The charging device 12 is, for example, a corona charger. The charging device 12 may be a contact charging device that charges a contact charging member such as a charging roller, a charging brush, or a charging blade in contact with the photosensitive drum 11. The exposing device 13 includes, for example, a semiconductor laser as a light source and a light deflecting device (polygon motor) that emits laser light according to an image to be formed toward the photosensitive drum 11.

The developing device 14 houses a developer containing toner therein and develops an electrostatic latent image on the photosensitive drum 11 with the toner to form a toner image on the photosensitive drum 11. That is, the toner image is thereby carried on the electrostatic latent image carrier. Here, the “toner image” refers to a state in which toner is aggregated in an image shape.

As the toner, known toner can be used. The toner may be a one-component developer or a two-component developer. The one-component developer is formed of toner particles. In addition, the two-component developer is formed of toner particles and carrier particles. Each of the toner particles is formed of a toner base particle and an external additive attached to a surface of the toner base particle, such as silica or a lubricant. Each of the toner base particles is formed of, for example, a binder resin, a colorant, and a wax.

The type of the lubricant is not particularly limited. Examples of the type of the lubricant include a metal soap such as zinc stearate, zinc palmitate, zinc myristate, zinc laurate, zinc behenate, magnesium stearate, calcium stearate, or aluminum stearate, various fatty acids, a fatty acid amide, a fatty acid ester, an aliphatic alcohol having 18 to 70 carbon atoms, a polyethylene, various waxes, polytetrafluoroethylene (PTFE), and various inorganic materials each having a layered crystal structure (boron nitride, melamine cyanurate, molybdenum disulfide, graphite fluoride, mica, or the like). Known types of lubricants can be used.

The lubricant is preferably a metal soap of a stearate or a zinc salt of a fatty acid, and particularly preferably zinc stearate from a viewpoint of easiness of spreading. In addition, the particle diameter of the lubricant is not particularly limited. However, the lubricant preferably has an average particle diameter of 10 μm or less from viewpoints of being able to increase the number of particles supplied per unit area, increasing spreading efficiency, and more easily exerting an effect of decreasing a dynamic frictional force as the diameter is smaller.

The intermediate transfer unit 20 includes an intermediate transfer body 21 stretched by a driving roller 24 and a driven roller 25 and circulating and traveling in a direction indicated by the arrow. The intermediate transfer body 21 has a seamless belt shape (that is, an endless belt shape), and has a cylindrical shape obtained by injection molding or centrifugal molding of a resin material so as to have a desired peripheral length determined by a design.

The belt cleaning device 26 includes a cleaning member (cleaning blade) 26a. The secondary transfer roller 22 is driven together with the driven roller 25 to secondarily transfer a toner image primarily transferred onto the intermediate transfer body 21 onto a recording medium.

Incidentally, in a case where color printing (color mode) is executed, each of the image forming units 10M to 10K forms a toner image of a color corresponding thereto on the photosensitive drum 11, and the formed toner image is transferred onto the intermediate transfer body 21. This image forming operation of each color of Y to K is executed in such a manner that the timing is shifted from an upstream side toward a downstream side such that the toner images of the respective colors overlap with one another to be transferred onto the same position of the traveling intermediate transfer body 21.

The sheet conveyer 30 sends out a sheet S as a recording medium one by one from a sheet feeding cassette in accordance with the above image forming timing and conveys the sheet S thus sent out on a conveyance path 31 toward the secondary transfer roller 22. The sheet S is heated and pressurized by the fixer 40. Toner on a surface of the sheet S is thereby fused and fixed to the surface of the sheet S. Thereafter, the sheet S is discharged onto a paper ejection tray 33 by a paper ejection roller 32. In this way, an image corresponding to a toner image is formed on a recording medium.

The sheet S onto which each color toner image has been secondarily transferred is conveyed to the fixer 40, and is heated and pressurized by the fixer 40. Toner on a surface of the sheet S is thereby fused and fixed to the surface of the sheet S. Thereafter, the sheet S is discharged onto the paper ejection tray 33 by the paper ejection roller 32. In this way, an image corresponding to a toner image is formed on a recording medium.

Incidentally, in the above, the operation in the case of executing a color mode has been described. However, in a case of executing printing in monochrome, for example, printing in black (monochrome mode), only the image forming unit 10K for black is driven, and black image formation (printing) is executed on the recording sheet S through charging, exposure, development, transfer, and fixing for black by a similar operation to the above.

The controller 45 controls each unit based on data of a print job accepted from an external terminal device via a network, and causes each unit to execute a smooth printing operation.

[Image Forming Method]

An image forming method according to an embodiment of the present invention includes: a primary transfer step of transferring a toner image carried on the photosensitive drum 11 onto the intermediate transfer body 21; a secondary transfer step of transferring the toner image carried on the intermediate transfer body 21 onto a recording medium; and a cleaning step of bringing the cleaning member 26a into contact with a surface of the intermediate transfer body 21 after the secondary transfer step to remove a residual toner remaining on the surface, and includes, for example, a charging step, an exposure step, a developing step, a transfer step, and a fixing step. In addition, the image forming method may further include a step of applying a lubricant having an average particle diameter of 10 μm or less to the intermediate transfer body 21.

In order to perform the image forming method according to the present embodiment, a device configured similarly to the image forming device 1 described above can be used.

In the charging step, a photosensitive drum is charged by a charging device or the like. The photosensitive drum is, for example, a negatively charged organic photoreceptor having photoconductivity. The organic photoreceptor includes, for example, a conductive support, a charge generation layer, a charge transport layer, and a surface layer.

In the exposure step, a charged photosensitive drum is irradiated with light by an exposure device or the like to form an electrostatic latent image.

In the developing step, toner is supplied to the photosensitive drum on which the electrostatic latent image is formed to form a toner image corresponding to the electrostatic latent image. The developing step can be performed using a known developing device in an electrophotographic image forming device, for example.

In the transfer step, the toner image on the photosensitive drum 11 is transferred onto the recording medium using a transfer unit. In the present embodiment, the transfer step includes a primary transfer step and a secondary transfer step. In the primary transfer step, the toner image on the photosensitive drum 11 is transferred onto the intermediate transfer body 21 by an electrostatic action using the primary transfer roller 15. In the secondary transfer step, the toner image on the intermediate transfer body 21 is transferred onto the recording medium using the secondary transfer roller 22. As described above, the image forming method according to the present embodiment is substantially an intermediate transfer method.

In the fixing step, the toner image transferred onto the recording medium is fixed to the recording medium by a known fixing device or the like.

Note that a drum cleaning step of removing toner remaining on the photosensitive drum 11 may be performed on the photosensitive drum 11 after the primary transfer. In addition, a belt cleaning step of removing toner remaining on the intermediate transfer body 21 may be performed on the intermediate transfer body 21 after the secondary transfer. The belt cleaning step is performed using the belt cleaning device 26 including the belt cleaning member (cleaning member) 26a. The belt cleaning device 26 cleans toner particles remaining on a surface of the intermediate transfer body 21 after transferring the toner image onto the recording medium by bringing the cleaning member 26a into contact with the surface. Examples of a method for cleaning residual toner particles include a method using a pressed cleaning blade, a method using a dedicated pressed blade for applying a lubricant, a method using a pressed brush, a method using a pressed rubber roller, a method using a pressed sponge roller, and a method using a pressed ultrathin (thickness: 0.3 mm or less) metal plate. The method for cleaning the residual toner particles is preferably a method using a cleaning blade from a viewpoint of reducing the number of required parts.

In addition, the method may further include a step of applying a lubricant to the intermediate transfer body 21. The step of applying a lubricant to the intermediate transfer body 21 is not particularly limited as long as being able to apply a lubricant to the intermediate transfer body 21. A lubricant may be directly applied to the intermediate transfer body 21 while the lubricant is scraped off from a solid lubricant with a brush or the like. Alternatively, using toner particles containing a lubricant therein, the lubricant may be supplied to the intermediate transfer body 21 by the toner. In the present embodiment, the step of applying a lubricant to the intermediate transfer body is a step of supplying the lubricant to the intermediate transfer body by toner using toner particles containing the lubricant therein. Note that the average particle diameter of the lubricant is 10 μm or less in any applying step.

As described above, in the present embodiment, since the above-described intermediate transfer body 21 according to an embodiment of the present invention is used, excellent surface releasability is obtained, cleaning performance of toner is improved, and the cleaning performance can be maintained over a long term.

### EXAMPLES

Hereinafter, the present invention will be specifically described with reference to Examples, but the present invention is not limited thereto.

[Manufacture of Intermediate Transfer Body 1]

(1) Manufacture of Base Layer 1

Into a single screw extruder, 100 parts by mass of polyphenylene sulfide resin (trade name: E2180, manufactured by Toray Industries, Inc.), 16 parts by volume of a conductive filler (trade name: Furnace #3030B, manufactured by Mitsubishi Chemical Corporation), 1 part by volume of a graft copolymer (trade name: Modiper A4400, manufactured by NOF CORPORATION), and 0.2 parts by volume of a lubricant (calcium montanate) were put and melt-kneaded to obtain a resin mixture.

Subsequently, an annular die having a slit-shaped and seamless belt-shaped discharge port was attached to a tip of the single screw extruder, and the kneaded resin mixture was extruded into a seamless belt shape. Then, the extruded seamless belt-shaped resin mixture was extrapolated to a cylindrical cooling cylinder disposed at a discharge destination and cooled to be solidified, and an intermediate transfer body base layer 1 having a thickness of 120 μm and having a seamless cylindrical shape (an endless belt shape) was thereby manufactured.

(2) Preparation of surface layer forming coating solution 1

In methyl isobutyl ketone (MIBK) as a solvent, 60 parts by volume of a polyfunctional monomer (trade name: “KAYARD DPEA12”, manufactured by Nippon Kayaku Co., Ltd.), 15 parts by volume of a long-chain alkyl monofunctional monomer (trade name: “Blemmer CA”, manufactured by NOF CORPORATION), and 25 parts by volume of metal oxide fine particles (trade name: “AEROSIL R 7200”, manufactured by Nippon Aerosil Co., Ltd., particle diameter about 12 nm, surface treatment: methacrylic treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 1.

Note that a difference in SP value (SP (M1)−SP (M2)) between a polyfunctional monomer and a long-chain alkyl monofunctional monomer used and SP (M2) are illustrated in Table I.

(3) Formation of Surface Layer 1

Using a coating device, the surface layer forming coating solution 1 was applied onto an outer peripheral surface of the base layer 1 by an immersion coating method under the following coating conditions so as to have a dry layer thickness of 3.8 μm to form a coated film.

Subsequently, by irradiating the coated film with ultraviolet rays as active rays (active energy rays) under the following irradiation conditions, the coated film was cured to form a surface layer. An intermediate transfer body 1 was thereby obtained. Note that the coated film was irradiated with ultraviolet rays while a light source was fixed and the precursor having the coated film formed on an outer peripheral surface of the base layer 1 was rotated at a peripheral rate of 60 mm/s.

(Coating Conditions)

Coating solution supply amount: 1 L/min

(Ultraviolet Ray Irradiation Conditions)

Type of light source: 365 nm LED light source (trade name: “SPX-TA”, manufactured by Eye Graphics Co., Ltd.)

Distance from irradiation port to surface of coated film: 60 mm

Atmosphere: nitrogen

Irradiation light amount: 1.4 J/cm²

Irradiation time (time to rotate precursor): 240 seconds

[Manufacture of Intermediate Transfer Body 2]

An intermediate transfer body 2 was manufactured in a similar manner to the manufacture of the intermediate transfer body 1 except for preparation of the following surface layer forming coating solution 2 in manufacture of the intermediate transfer body 1.

(1) Preparation of Surface Layer Forming Coating Solution 2

In methyl isobutyl ketone (MIBK) as a solvent, 60 parts by volume of a polyfunctional monomer (trade name: “KAYARD DPCA60”, manufactured by Nippon Kayaku Co., Ltd.), 15 parts by volume of a long-chain alkyl monofunctional monomer (trade name: “Blemmer LMA”, manufactured by NOF CORPORATION), and 25 parts by volume of metal oxide fine particles (trade name: “AEROSIL R 7200”, manufactured by Nippon Aerosil Co., Ltd., particle diameter about 12 nm, surface treatment: methacrylic treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 2.

[Manufacture of Intermediate Transfer Body 3]

An intermediate transfer body 3 was manufactured in a similar manner to the manufacture of the intermediate transfer body 1 except for preparation of the following surface layer forming coating solution 3 in manufacture of the intermediate transfer body 1.

(1) Preparation of Surface Layer Forming Coating Solution 3

In methyl isobutyl ketone (MIBK) as a solvent, 60 parts by volume of a polyfunctional monomer (trade name: “A-DPH-6P”, manufactured by Shin-Nakamura Chemical Co., Ltd.), 15 parts by volume of a long-chain alkyl monofunctional monomer (trade name: “Light Ester ID”, manufactured by Kyoeisha Chemical Co., Ltd.), and 25 parts by volume of metal oxide fine particles (trade name: “AEROSIL R 7200”, manufactured by Nippon Aerosil Co., Ltd., particle diameter about 12 nm, surface treatment: methacrylic treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 3.

[Manufacture of Intermediate Transfer Body 4]

An intermediate transfer body 4 was manufactured in a similar manner to the manufacture of the intermediate transfer body 1 except for preparation of the following surface layer forming coating solution 4 in manufacture of the intermediate transfer body 1.

(1) Preparation of Surface Layer Forming Coating Solution 4

In methyl isobutyl ketone (MIBK) as a solvent, 60 parts by volume of a polyfunctional monomer (trade name: “SR9003”, manufactured by Sartomer), 15 parts by volume of a long-chain alkyl monofunctional monomer (trade name: “Blemmer VMA”, manufactured by NOF CORPORATION), and 25 parts by volume of metal oxide fine particles (trade name: “AEROSIL R 7200”, manufactured by Nippon Aerosil Co., Ltd., particle diameter about 12 nm, surface treatment: methacrylic treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 4.

[Manufacture of Intermediate Transfer Body 5]

An intermediate transfer body 5 was manufactured in a similar manner to the manufacture of the intermediate transfer body 1 except for preparation of the following surface layer forming coating solution 5 in manufacture of the intermediate transfer body 1.

(1) Preparation of Surface Layer Forming Coating Solution 5

In methyl isobutyl ketone (MIBK) as a solvent, 60 parts by volume of a polyfunctional monomer (trade name: “A-DPH-6P”, manufactured by Shin-Nakamura Chemical Co., Ltd.), 15 parts by volume of a long-chain alkyl monofunctional monomer (trade name: “Blemmer VA”, manufactured by NOF CORPORATION), and 25 parts by volume of metal oxide fine particles (trade name: “AEROSIL R 7200”, manufactured by Nippon Aerosil Co., Ltd., particle diameter about 12 nm, surface treatment: methacrylic treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 5.

[Manufacture of Intermediate Transfer Body 6]

An intermediate transfer body 6 was manufactured in a similar manner to the manufacture of the intermediate transfer body 1 except for preparation of the following surface layer forming coating solution 6 in manufacture of the intermediate transfer body 1.

(1) Preparation of Surface Layer Forming Coating Solution 6

In methyl isobutyl ketone (MIBK) as a solvent, 70 parts by volume of a polyfunctional monomer (trade name: “SR9003”, manufactured by Sartomer), 5 parts by volume of a long-chain alkyl monofunctional monomer (trade name: “Light Ester DTD-MA”, manufactured by Kyoeisha Chemical Co., Ltd.), and 25 parts by volume of metal oxide fine particles (trade name: “AEROSIL R 202”, manufactured by Nippon Aerosil Co., Ltd., particle diameter about 14 nm, surface treatment: dimethyl silicone treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 6.

[Manufacture of Intermediate Transfer Body 7]

An intermediate transfer body 7 was manufactured in a similar manner to the manufacture of the intermediate transfer body 1 except for preparation of the following surface layer forming coating solution 7 in manufacture of the intermediate transfer body 1.

(1) Preparation of Surface Layer Forming Coating Solution 7

In methyl isobutyl ketone (MIBK) as a solvent, 55 parts by volume of a polyfunctional monomer (trade name: “A-DPH-6P”, manufactured by Shin-Nakamura Chemical Co., Ltd.), 20 parts by volume of a long-chain alkyl monofunctional monomer (trade name: “Blemmer SA”, manufactured by NOF CORPORATION), and 25 parts by volume of metal oxide fine particles (trade name: “AEROSIL R 7200”, manufactured by Nippon Aerosil Co., Ltd., particle diameter about 12 nm, surface treatment: methacrylic treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 7.

[Manufacture of Intermediate Transfer Body 8]

An intermediate transfer body 8 was manufactured in a similar manner to the manufacture of the intermediate transfer body 1 except for preparation of the following surface layer forming coating solution 8 in manufacture of the intermediate transfer body 1.

(1) Preparation of Surface Layer Forming Coating Solution 8

In methyl isobutyl ketone (MIBK) as a solvent, 60 parts by volume of a polyfunctional monomer (trade name: “KAYARD DPEA12”, manufactured by Nippon Kayaku Co., Ltd.), 15 parts by volume of a long-chain alkyl monofunctional monomer (trade name: “Light Ester EH”, manufactured by Kyoeisha Chemical Co., Ltd.), and 25 parts by volume of metal oxide fine particles (trade name: “AEROSIL R 7200”, manufactured by Nippon Aerosil Co., Ltd., particle diameter about 12 nm, surface treatment: methacrylic treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 8.

[Manufacture of Intermediate Transfer Body 9]

An intermediate transfer body 9 was manufactured in a similar manner to the manufacture of the intermediate transfer body 1 except for preparation of the following surface layer forming coating solution 9 in manufacture of the intermediate transfer body 1.

(1) Preparation of Surface Layer Forming Coating Solution 9

In methyl isobutyl ketone (MIBK) as a solvent, 60 parts by volume of a polyfunctional monomer (trade name: “D-TMP”, manufactured by Shin-Nakamura Chemical Co., Ltd.), 15 parts by volume of a long-chain alkyl monofunctional monomer (trade name: “Blemmer LA”, manufactured by NOF CORPORATION), and 25 parts by volume of metal oxide fine particles (trade name: “AEROSIL R 7200”, manufactured by Nippon Aerosil Co., Ltd., particle diameter about 12 nm, surface treatment: methacrylic treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 9.

[Manufacture of Intermediate Transfer Body 10]

An intermediate transfer body 10 was manufactured in a similar manner to the manufacture of the intermediate transfer body 1 except for preparation of the following surface layer forming coating solution 10 in manufacture of the intermediate transfer body 1.

(1) Preparation of Surface Layer Forming Coating Solution 10

In methyl isobutyl ketone (MIBK) as a solvent, 45 parts by volume of a polyfunctional monomer (trade name: “KAYARD DPEA12”, manufactured by Nippon Kayaku Co., Ltd.), 30 parts by volume of a long-chain alkyl monofunctional monomer (trade name: “Light Ester EH”, manufactured by Kyoeisha Chemical Co., Ltd.), and 25 parts by volume of metal oxide fine particles (trade name: “AEROSIL R 7200”, manufactured by Nippon Aerosil Co., Ltd., particle diameter about 12 nm, surface treatment: methacrylic treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 10.

[Manufacture of Intermediate Transfer Body 11]

An intermediate transfer body 11 was manufactured in a similar manner to the manufacture of the intermediate transfer body 1 except for preparation of the following surface layer forming coating solution 11 in manufacture of the intermediate transfer body 1.

(1) Preparation of Surface Layer Forming Coating Solution 11

In methyl isobutyl ketone (MIBK) as a solvent, 74 parts by volume of a polyfunctional monomer (trade name: “A-DPH-6P”, manufactured by Shin-Nakamura Chemical Co., Ltd.), 1 part by volume of a long-chain alkyl monofunctional monomer (trade name: “Blemmer VA”, manufactured by NOF CORPORATION), and 25 parts by volume of metal oxide fine particles (trade name: “AEROXIDE TiO₂ NKT 90”, manufactured by Nippon Aerosil Co., Ltd., particle diameter about 14 nm, surface treatment: alkylsilyl treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 11.

[Manufacture of Intermediate Transfer Body 12]

An intermediate transfer body 12 was manufactured in a similar manner to the manufacture of the intermediate transfer body 1 except for preparation of the following surface layer forming coating solution 12 in manufacture of the intermediate transfer body 1.

(1) Preparation of Surface Layer Forming Coating Solution 12

In methyl isobutyl ketone (MIBK) as a solvent, 70 parts by volume of a polyfunctional monomer (trade name: “SR9003”, manufactured by Sartomer), 5 parts by volume of a long-chain alkyl monofunctional monomer (trade name: “ISTA”, manufactured by Osaka Organic Chemical Industry Ltd.), and 25 parts by volume of metal oxide fine particles (trade name: “AEROXIDE TiO₂ NKT 90”, manufactured by Nippon Aerosil Co., Ltd., particle diameter about 14 nm, surface treatment: alkylsilyl treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 12.

[Manufacture of Intermediate Transfer Body 13]

An intermediate transfer body 13 was manufactured in a similar manner to the manufacture of the intermediate transfer body 1 except for preparation of the following surface layer forming coating solution 13 in manufacture of the intermediate transfer body 1.

(1) Preparation of Surface Layer Forming Coating Solution 13

In methyl isobutyl ketone (MIBK) as a solvent, 47.5 parts by volume of a polyfunctional monomer (trade name: “KAYARD DPHA”, manufactured by Nippon Kayaku Co., Ltd.), 27.5 parts by volume of a long-chain alkyl monofunctional monomer (trade name: “Blemmer SA”, manufactured by NOF CORPORATION), and 25 parts by volume of metal oxide fine particles (trade name: “AEROSIL R 202”, manufactured by Nippon Aerosil Co., Ltd., particle diameter about 14 nm, surface treatment: dimethyl silicone treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 13.

[Manufacture of Intermediate Transfer Body 14]

An intermediate transfer body 14 was manufactured in a similar manner to the manufacture of the intermediate transfer body 1 except for preparation of the following surface layer forming coating solution 14 in manufacture of the intermediate transfer body 1.

(1) Preparation of Surface Layer Forming Coating Solution 14

In methyl isobutyl ketone (MIBK) as a solvent, 70 parts by volume of a polyfunctional monomer (trade name: “KAYARD DPCA20”, manufactured by Nippon Kayaku Co., Ltd.), 5 parts by volume of a long-chain alkyl monofunctional monomer (trade name: “Blemmer VMA”, manufactured by NOF CORPORATION), and 25 parts by volume of metal oxide fine particles (trade name: “AEROSIL R 202”, manufactured by Nippon Aerosil Co., Ltd., particle diameter about 14 nm, surface treatment: dimethyl silicone treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 14.

[Manufacture of Intermediate Transfer Body 15]

An intermediate transfer body 15 was manufactured in a similar manner to the manufacture of the intermediate transfer body 1 except for preparation of the following surface layer forming coating solution 15 in manufacture of the intermediate transfer body 1.

(1) Preparation of Surface Layer Forming Coating Solution 15

In methyl isobutyl ketone (MIBK) as a solvent, 70 parts by volume of a polyfunctional monomer (trade name: “KAYARD PET-30”, manufactured by Nippon Kayaku Co., Ltd.), 5 parts by volume of a long-chain alkyl monofunctional monomer (trade name: “Light Ester ID”, manufactured by Kyoeisha Chemical Co., Ltd.), and 25 parts by volume of metal oxide fine particles (trade name: “AEROSIL R 202”, manufactured by Nippon Aerosil Co., Ltd., particle diameter about 14 nm, surface treatment: dimethyl silicone treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 15.

[Manufacture of Intermediate Transfer Body 16]

An intermediate transfer body 16 was manufactured in a similar manner to the manufacture of the intermediate transfer body 1 except for preparation of the following surface layer forming coating solution 16 in manufacture of the intermediate transfer body 1.

(1) Preparation of Surface Layer Forming Coating Solution 16

In methyl isobutyl ketone (MIBK) as a solvent, 47.5 parts by volume of a polyfunctional monomer (trade name: “KAYARD DPHA”, manufactured by Nippon Kayaku Co., Ltd.), 27.5 parts by volume of a long-chain alkyl monofunctional monomer (trade name: “Blemmer LA”, manufactured by NOF CORPORATION), and 25 parts by volume of metal oxide fine particles (trade name: “AEROXIDE TiO₂ NKT 90”, manufactured by Nippon Aerosil Co., Ltd., particle diameter about 14 nm, surface treatment: alkylsilyl treatment) were dissolved and dispersed so as to obtain a solid concentration of 10% by mass to prepare a diluted solution. With respect to 100 parts by mass of the diluted solution, 1 part by mass of a photopolymerization initiator (trade name: Irgacure TPO, manufactured by BASF) was mixed to prepare a surface layer forming coating solution 16.

### Evaluation

Evaluation was performed for the following evaluations 1 to 4, and the results are illustrated in Table II.

### <Evaluation 1> Initial Cleaning Performance (Wiping Property of Toner)

(Preparation of Evaluation Device)

As an evaluation device, a remodeled machine of a commercially available full-color multifunction machine (bizhub (registered trademark) C554e: Konica Minolta Inc.) was prepared. Specifically, a transfer unit was assembled using the intermediate transfer bodies 1 to 15 described above. In addition, a single drive machine for a transfer unit equipped with a strain gauge was prepared. Furthermore, a remodeled machine including the above transfer unit was prepared.

A cleaning blade abraded in advance by 30 μm was used. Here, the cleaning blade abraded in advance by 30 μm means a cleaning blade having a maximum abrasion width d of 30 μm as illustrated in FIG. 2. The maximum abrasion width d means a length between an end of an abraded portion on the left side of the cleaning blade and an end of an abraded portion on the right side of the cleaning blade. For the abrasion width of the cleaning blade, the cleaning blade was tilted by 45°, and a contact portion with the intermediate transfer body was measured with a laser microscope (Vk-X100, objective lens with a magnification of 150 times, observation with a step width of 0.1 μm; Keyence Corp.).

Evaluation toner was attached to an edge portion of such a cleaning blade. As the evaluation toner, toner for bizhub (registered trademark) C554e (TN512) was used.

In a width direction of the intermediate transfer body, in a peripheral direction of the intermediate transfer body in the entire range in which the cleaning blade is in contact, the evaluation toner was uniformly attached to a position immediately before the cleaning blade and within a range of ⅓ of the entire periphery such that the attachment amount was 0.4 g/m² for setting.

Note that UW085 (manufactured by NOK Co., Ltd., thickness: 2.0 mm) was used as the cleaning blade. An abutting force to the intermediate transfer body was set to 30 N/m, an effective contact angle to the intermediate transfer body was set to 14°, and a free length was set to 9 mm.

A new intermediate transfer body was used.

With respect to the initial cleaning performance, in a state where the secondary transfer unit was removed, using toner of 4.0 g/m², printing was performed on an A3 size intermediate transfer body, and a wiping state of the toner on the intermediate transfer body after completion of printing was observed. At this time, conditions of a biting pressure of the cleaning blade were changed, and a toner wiping property for each biting pressure of the cleaning blade was evaluated.

⊙: Toner can be wiped off even when a biting pressure of the cleaning blade is 10 N/m

◯: Toner can be wiped off even when a biting pressure of the cleaning blade is 20 N/m

Δ: Toner can be wiped off even when a biting pressure of the cleaning blade is 30 N/m

x: A toner wiping residue is generated when a biting pressure of the cleaning blade is 30 N/m Evaluation of equal to or higher than ◯ was judged as being acceptable.

### <Evaluation 2> Cleaning Performance after Polishing (Toner Wiping Property after Polishing Test)

An evaluation device was prepared similarly to the above <Evaluation 1>. Instead of the new intermediate transfer body, the following intermediate transfer body was used.

Polishing paper having a roughness of 30 μm was pressed on an intermediate transfer body at a pressure of 5 N/m in a longitudinal direction of the intermediate transfer body, and the intermediate transfer body was driven at a speed of 100 mm/sec for 20 minutes to be used.

Except for this, a toner wiping property after a polishing test was evaluated in a similar manner to evaluation of (1) initial cleaning performance.

### <Evaluation 3> Roughness after Polishing Test

Prior to the above <Evaluation 2>, the roughness immediately after polishing of the intermediate transfer body was measured, and the roughness after a polishing test was evaluated. For the measurement of the roughness, observation was performed with a laser microscope (Vk-X100, objective lens with a magnification of 20 times, observation with a step width of 0.1 μm Keyence Corp.) to obtain a height profile, in-plane distortion was corrected, and then roughness Ra of the entire surface was calculated.

⊙: Ra is less than 0.3 μm

◯: Ra is 0.3 nm or more and less than 0.6 μm

Δ: Ra is 0.6 μm or more and less than 1.0 μm

x: Ra is 1.0 μm or more

Evaluation of equal to or higher than ◯ was judged as being acceptable.

### <Evaluation 4> Turnover in HH Environment

The intermediate transfer body after evaluation of the cleaning performance after polishing in the <Evaluation 2> was subjected to humidity conditioning overnight in an HH environment (30° C., 80% RH), and then evaluation was performed.

A transfer unit was assembled in a similar manner to <Evaluation 1> and <Evaluation 2> except that a new cleaning blade was used. The single drive machine was driven such that a belt moving speed was 280 mm/sec, and was operated for 30 seconds. Presence or absence of turnover of the cleaning blade at this time was used as an evaluation result. If turnover has not occurred, it is judged as being acceptable.

TABLE I

| | Polyfunctional monomer | | | | | Long-chain alkyl | | Difference | | |
|---|---|---|---|---|---|---|---|---|---|---|
| | | X | | | m + n | monofunctional monomer | | in SP value | | |
| Coating | | Number of | Connecting group | M | Number of | Number of | | SP (M1) − | | |
| solution | A | connected | having chain | Functional | functional | connected | Functional | SP (M2) | SP (M2) | |
| No. | Structure | atoms | skeleton | group | groups | carbon atoms | group | [(cal/cm³)^{1/2}] | [(cal/cm³)^{1/2}] | Note |
| 1 | A9 | 6 | Oxyethylene | Acryloyl | 6 | 16 | Acryloyl | 1.7 | 8.8 | Present |
| | | | chain | | | | | | | invention |
| 2 | A9 | 6 | Alkylene | Acryloyl | 6 | 12 | Methacryloyl | 1.9 | 8.7 | Present |
| | | | oxide group | | | | | | | invention |
| 3 | A9 | 3 | Oxypropylene | Acryloyl | 6 | 7 | Methacryloyl | 1.5 | 8.6 | Present |
| | | | chain | | | | | | | invention |
| 4 | A4 | 3 | Oxypropylene | Acryloyl | 2 | 22 | Methacryloyl | 0.7 | 8.8 | Present |
| | | | chain | | | | | | | invention |
| 5 | A9 | 3 | Oxypropylene | Acryloyl | 6 | 22 | Acryloyl | 1.4 | 8.8 | Present |
| | | | chain | | | | | | | invention |
| 6 | A4 | 3 | Oxypropylene | Acryloyl | 2 | 14 | Methacryloyl | 0.8 | 8.7 | Present |
| | | | chain | | | | | | | invention |
| 7 | A9 | 3 | Oxypropylene | Acryloyl | 6 | 18 | Acryloyl | 1.7 | 8.8 | Present |
| | | | chain | | | | | | | invention |
| 8 | A9 | 6 | Oxyethylene | Acryloyl | 6 | 6 | Methacryloyl | 1.7 | 8.9 | Present |
| | | | chain | | | | | | | invention |
| 9 | A8 | 0 | None | Methacryloyl | 4 | 12 | Acryloyl | 1.2 | 8.9 | Present |
| | | | | | | | | | | invention |
| 10 | A9 | 6 | Oxyethylene | Acryloyl | 6 | 6 | Methacryloyl | 1.7 | 8.9 | Present |
| | | | chain | | | | | | | invention |
| 11 | A9 | 3 | Oxypropylene | Acryloyl | 6 | 22 | Acryloyl | 1.7 | 8.8 | Present |
| | | | chain | | | | | | | invention |
| 12 | A4 | 3 | Oxypropylene | Acryloyl | 2 | 8 | Acryloyl | 1.3 | 8.2 | Present |
| | | | chain | | | | | | | invention |
| 13 | A9 | 0 | None | Acryloyl | 6 | 18 | Acryloyl | 2.25 | 8.8 | Comparative |
| | | | | | | | | | | Example |
| 14 | A9 | 2 | Alkylene oxide | Acryloyl | 6 | 22 | Methacryloyl | 2.11 | 8.8 | Comparative |
| | | | group | | | | | | | Example |
| 15 | A7 | 0 | None | Acryloyl | 4 | 7 | Methacryloyl | 2.41 | 8.6 | Comparative |
| | | | | | | | | | | Example |
| 16 | A9 | 0 | None | Acryloyl | 6 | 12 | Acryloyl | 2.16 | 8.9 | Comparative |
| | | | | | | | | | | Example |

TABLE II

| | | Evaluation result | | | | |
|---|---|---|---|---|---|---|
| Intermediate | Coating | Initial | Cleaning | Roughness | | |
| transfer | solution | cleaning | performance | after polishing | | |
| body No. | No. | performance | after polishing | (Ra) | Turnover in HH environment | Note |
| 1 | 1 | ⊙ | ◯ | ⊙ | Squeak occurs but turnover does not occur | Present invention |
| 2 | 2 | ⊙ | ◯ | ⊙ | None | Present invention |
| 3 | 3 | ◯ | ◯ | ⊙ | None | Present invention |
| 4 | 4 | ⊙ | ◯ | ◯ | None | Present invention |
| 5 | 5 | ⊙ | ⊙ | ⊙ | None | Present invention |
| 6 | 6 | ◯ | ◯ | ◯ | None | Present invention |
| 7 | 7 | ⊙ | ⊙ | ⊙ | None | Present invention |
| 8 | 8 | ◯ | ◯ | ⊙ | Squeak occurs but turnover does not occur | Present invention |
| 9 | 9 | ⊙ | ◯ | ◯ | Squeak occurs but turnover does not occur | Present invention |
| 10 | 10 | ◯ | ◯ | ◯ | Squeak occurs but turnover does not occur | Present invention |
| 11 | 11 | ◯ | ◯ | ◯ | None | Present invention |
| 12 | 12 | ◯ | ◯ | ◯ | None | Present invention |
| 13 | 13 | ⊙ | Δ | Δ | Turnover occurs | Comparative Example |
| 14 | 14 | ⊙ | Δ | Δ | Squeak occurs but turnover does not occur | Comparative Example |
| 15 | 15 | ◯ | X | X | Turnover occurs | Comparative Example |
| 16 | 16 | ⊙ | X | Δ | Turnover occurs | Comparative Example |

The results illustrated in Table II indicate that the intermediate transfer body according to an embodiment of the present invention is superior to the intermediate transfer body in Comparative Example in evaluation of initial cleaning performance, cleaning performance after polishing, roughness after a polishing test, and turnover in an HH environment.

According to an embodiment of the present invention, it is possible to provide an intermediate transfer body capable of improving cleaning performance of toner and maintaining the cleaning performance over a long term, a method for manufacturing the intermediate transfer body, and an image forming device.

An exhibition mechanism or an action mechanism of an effect of an embodiment of the present invention has not been clarified but is estimated as follows.

According to an embodiment of the present invention, a surface layer includes a polymer obtained by polymerizing a polyfunctional monomer and a long-chain alkyl monofunctional monomer, and the long-chain alkyl monofunctional monomer has a hydrophobic long-chain alkyl and a functional group. Therefore, the polymer obtained by polymerizing the long-chain alkyl monofunctional monomer and the polyfunctional monomer tends to be oriented to the outside of a polymer skeleton after polymerization. As a result, cleaning performance of toner is improved by a releasing effect.

Originally, the long-chain alkyl monofunctional monomer has a low SP value and is segregated on a surface of a surface layer or inside the surface layer when being mixed with the polyfunctional monomer, and impairs a water and oil repellent effect when being abraded. However, by making a design such that SP values of the polyfunctional monomer and the long-chain alkyl monofunctional monomer satisfy the following formula (A), it is possible to obtain a favorable compatibilized state between the polyfunctional monomer and the long-chain alkyl monofunctional monomer and to suppress segregation inside the surface layer. Therefore, it is possible to maintain cleaning performance over a long term.

Although embodiments of the present invention have been described and illustrated in detail, the disclosed embodiments are made for purposes of illustration and example only and not limitation. The scope of the present invention should be interpreted by terms of the appended claims.

What is claimed is:

1. An intermediate transfer body used for an electrophotographic image forming device, the intermediate transfer body comprising:
at least a base layer, and
a surface layer, wherein
the surface layer includes a polymer obtained by polymerizing a polyfunctional monomer and a monofunctional monomer having a long-chain alkyl group, and
a solubility parameter (SP (M1)) of the polyfunctional monomer (M1) and a solubility parameter (SP (M2)) of the long-chain alkyl monofunctional monomer (M2) satisfy the following formulas (A) and (B):
SP(M1)−SP(M2)<2.0(cal/cm³)^{1/2} Formula (A);
and
8.0≤SP(M2)≤9.0(cal/cm³)^{1/2} Formula (B).

2. The intermediate transfer body according to claim 1, wherein the long-chain alkyl monofunctional monomer is a long-chain alkyl monofunctional monomer in which 6 or more carbon atoms are connected.

3. The intermediate transfer body according to claim 1, wherein the long-chain alkyl monofunctional monomer is a long-chain alkyl monofunctional monomer in which 12 or more carbon atoms are connected.

4. The intermediate transfer body according to claim 1, wherein the polyfunctional monomer has a structure represented by the following general formula (1):
A-[(X)-M]ₘ(M)ₙ, General formula (1)
[where, A represents a bifunctional or higher functional monomer, X represents a connecting group having a chain skeleton in which three or more atoms on an average are connected, and at least one of the atoms is a carbon, nitrogen or oxygen atom; M represents a photopolymerizable functional group; and each of m and n represents the number of functional groups and is an integer of 1 or more, and m+n is an integer of 2 to 6].

5. The intermediate transfer body according to claim 4, wherein the X has a skeleton of either an oxypropylene chain or an alkylene oxide chain.

6. The intermediate transfer body according to claim 1, wherein the polyfunctional monomer has five or more functional groups.

7. The intermediate transfer body according to claim 1, wherein the surface layer includes a polymer obtained by polymerizing a monomer having an acryloyl group or a methacryloyl group.

8. The intermediate transfer body according to claim 1, wherein the content of a constituent derived from the long-chain alkyl monofunctional monomer is within a range of 5 to 20 parts by volume with respect to the total volume (100 parts by volume) of the surface layer.

9. A method for manufacturing the intermediate transfer body according to claim 1, the method comprising
using a surface layer forming coating solution containing a long-chain alkyl monofunctional monomer within a range of 5 to 20 parts by volume with respect to the total volume (100 parts by volume) of solid components constituting the surface layer.

10. An image forming device comprising the intermediate transfer body according to claim 1.
